(19) United States
(12) Patent Application Publication
(10) Pub. No.: US 2019/0191788 A1
(43) Pub. Date: Jun. 27, 2019

(54) METHOD OF MANUFACTURING FEATHER-FILLED ITEMS OF CLOTHING

(71) Applicant: MONCLER S.P.A., Milano (IT)

(72) Inventor: Giovanni ZORZIN, Thiene (IT)

(73) Assignee: MONCLER S.p.A., Milano (IT)

(21) Appl. No.: 16/309,831

(22) PCT Filed: Jun. 12, 2017
(86) PCT No.: PCT/EP2017/064290

§ 371 Date: Dec. 13, 2018

(30) Foreign Application Priority Data
Jun. 14, 2016 (IT) 102016000060837

(51) Int. Cl. A41D 1/02; A41H 43/00; B29C 51/08; B29C 51/10; B29C 51/26; B29C 65/02; B29C 65/48; B29C 65/00; A41D 3/02

(52) U.S. Cl. CPC A41D 1/02; B29K 2711/00; B29C 51/082; B29C 51/10; B29C 51/266; B29C 65/02; B29C 65/48; B29C 66/1122; B29C 66/133; B29C 66/24243; B29C 66/433; B29C 66/71; B29C 66/7294; A41D 3/02; B29C 2791/006; A41H 43/00

(57) ABSTRACT

A method of manufacturing feather-filled items of clothing includes the following steps: preparing at least one mold provided with first concavities of shape substantially complementary to a respective padded cambered region of at least one portion of the item of clothing to be obtained; and associating a first sheet of deformable material with the mold. The method further includes deforming the first sheet against the mold so as to obtain, on the first sheet, second concavities that substantially correspond to the first concavities of the mold. Then, each second concavity of the first sheet is filled with down, and a second sheet is anchored to the first sheet. The semi-finished product is removed from the mold.

### TECHNICAL FIELD

The present disclosure relates to a method of manufacturing feather-filled items of clothing, in particular of jackets and coats padded with goose down, also known as “down jackets”.

### BACKGROUND

Padded items of clothing are known which have at least two layers of fabric or “triplure”, a plurality of stitched seams, for example parallel, and a certain quantity of goose down contained in the volumes enclosed between the two layers and defined between the stitched seams, in order to create a cambered effect in each band comprised between two seams

The seams to keep in the down feathers are made by sewing and this entails some problems.

A first problem is feather loss, i.e. the possibility that the down feathers may migrate from one volume to another or outside the item of clothing.

Furthermore, there may be reductions in the volume of the camber.

Another problem is that the camber created by stitched seams and down feathers protrudes both outward from the fabric and inward and it is not possible to limit it to just one of the two sides of the item of clothing.

### SUMMARY

The aim of the present disclosure is to provide a method of manufacturing filled items of clothing, in particular feather-filled, which is capable of improving the prior art in one or more of the above mentioned aspects.

Within this aim, the present disclosure provides a method of manufacturing feather-filled items of clothing that eliminates or at least appreciably reduces the problems of feather loss in the prior art.

The disclosure also provides a method of manufacturing feather-filled items of clothing that makes it possible to limit the camber of the item of clothing to only outward or only inward.

The present disclosure provides the reduction of production times with respect to the known art of producing down jackets.

Furthermore, the present disclosure further overcomes the known drawbacks in a different manner to any existing solutions.

The present disclosure provides a method that is highly reliable, easy to implement and low cost.

This aim and these and other advantages which will become better apparent hereinafter are achieved by providing the method according to claim 1, optionally with the characteristics of the dependent claims.

### BRIEF DESCRIPTION OF THE DRAWINGS

Further characteristics and advantages of the disclosure will become better apparent from the description of a preferred, but not exclusive, embodiment of the method according to the disclosure, which is illustrated by way of non-limiting example in the accompanying drawings wherein:

FIG. 1 is an exploded view of the components used in an embodiment of the disclosure;

FIG. 2 shows the step of associating a first sheet with the mold;

FIG. 3 shows the fixing of the first sheet to the mold;

FIG. 4 shows the step of deforming the first sheet;

FIG. 5 shows the insertion of down feather pads;

FIG. 6 shows the superimposition of a second sheet;

FIG. 7 shows the fixing of the second sheet to the first sheet; and

FIG. 8 shows the semi-finished product obtained with the first embodiment.

### DETAILED DESCRIPTION OF THE DRAWINGS

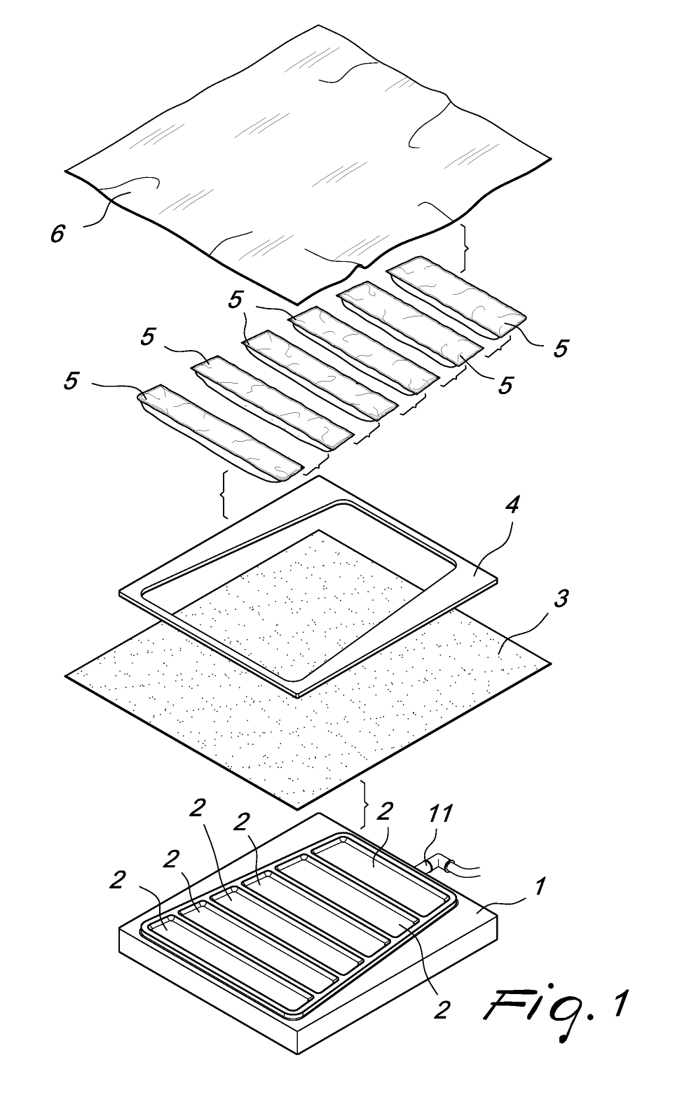

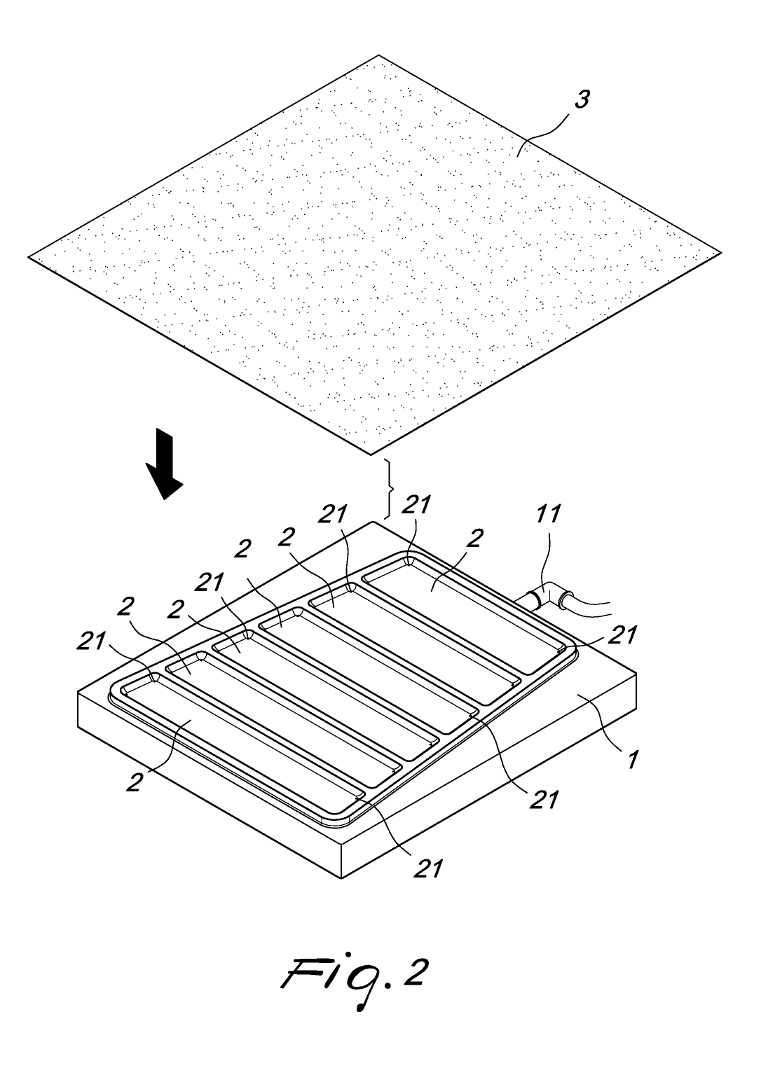

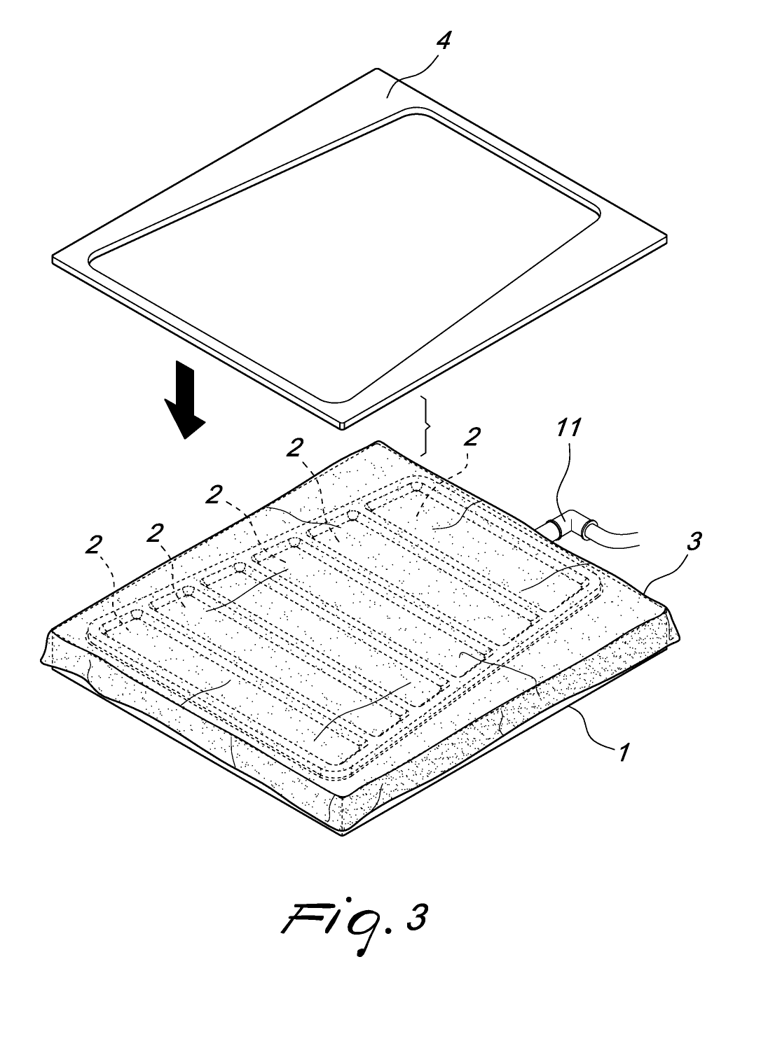

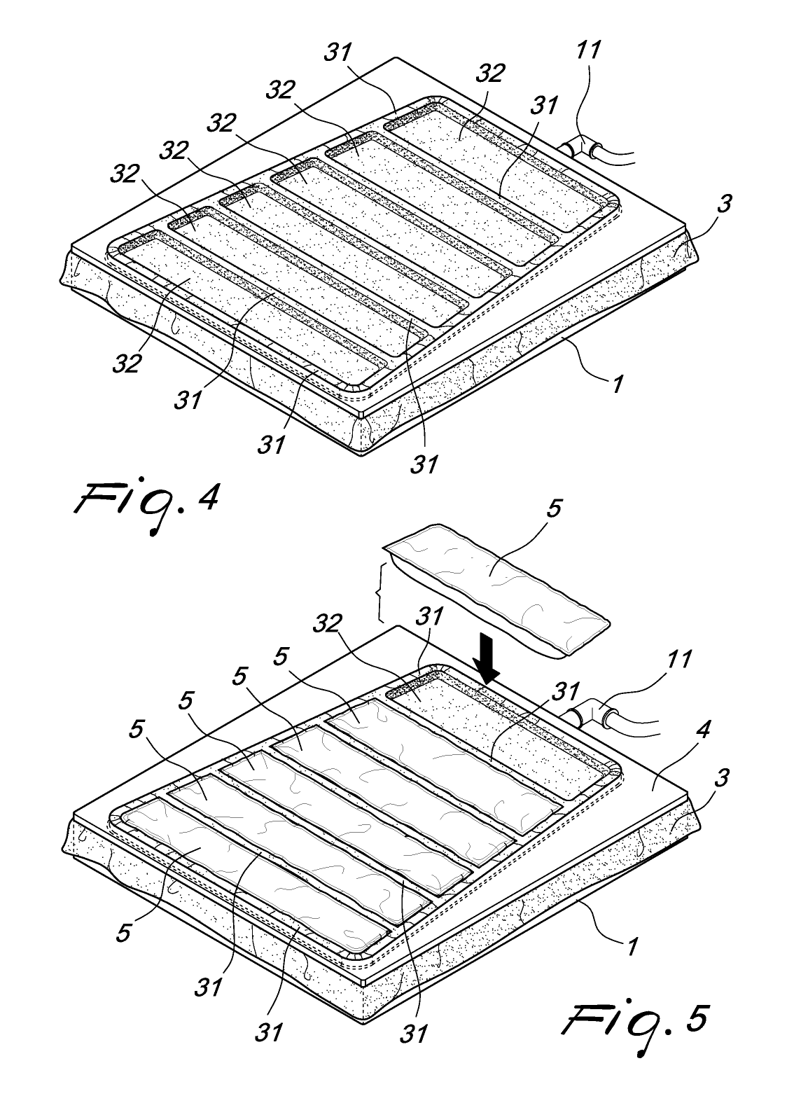

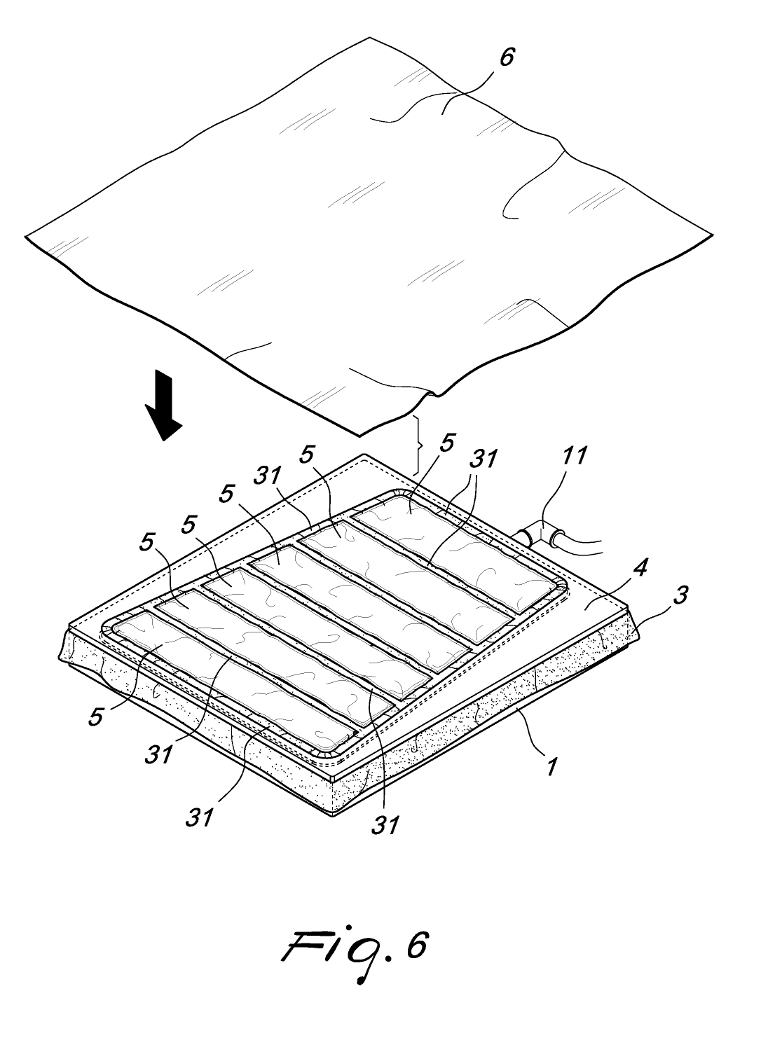

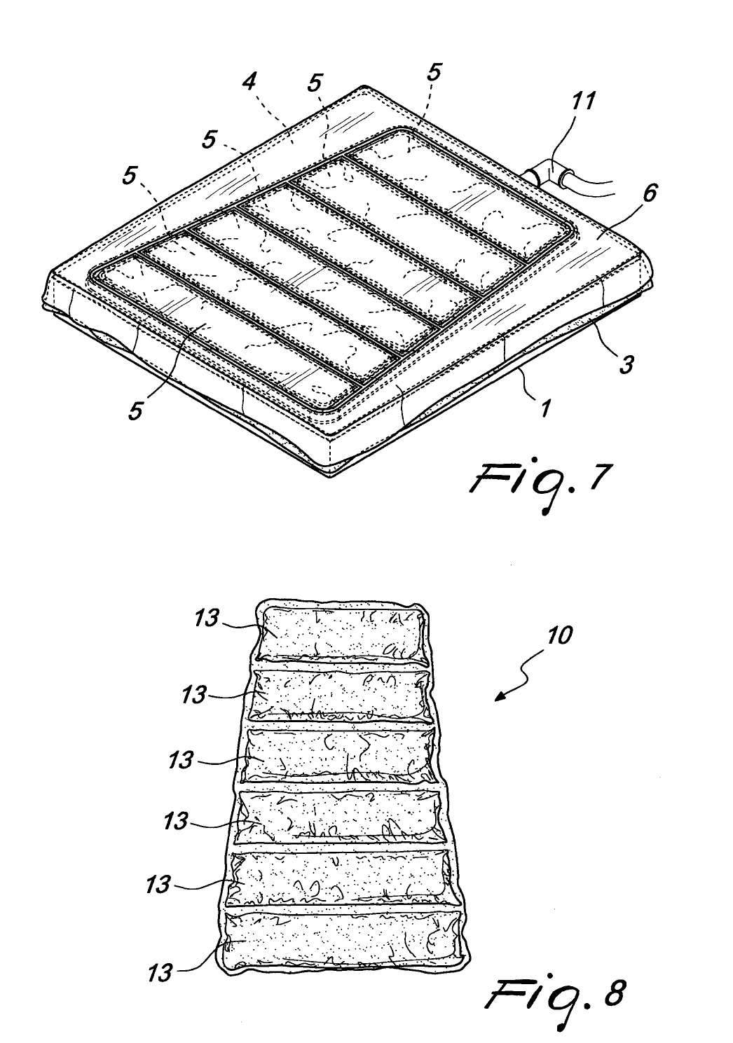

With reference to FIGS. 1-8, the method according to the disclosure involves first of all preparing an adapted mold 1, for example made of metal, provided with a plurality of first concavities 2 of shape substantially complementary to a respective padded cambered region of at least one portion of the item of clothing to be obtained.

For example, the figures show a mold 1 that was previously obtained starting from a paper model of a portion of a padded down jacket with a boudin effect.

The mold 1 is female and its first concavities 2 are shaped with a substantially rectangular base and are substantially mutually parallel.

At least one first sheet 3 of deformable material is arranged over the mold 1, and is fixed temporarily to the mold, for example by mechanical to interference of a frame 4 with an internal profile corresponding to the external perimeter of the mold 1.

The first sheet 3 can be a piece of fabric, or of non-woven fabric, or of “triplure”, or of a material with a permanent deformation or thermoforming temperature, for example EVA or silicone.

Subsequently, the first sheet 3 is subjected to a deformation against the mold 1 so as to obtain, on the first sheet 3, second concavities 32 that substantially correspond to the first concavities 2 of the mold 1.

The deformation can be obtained by way of depressurizing the volume defined between the first sheet 3 applied to the mold 1 and the first concavities 2 of that mold, which is conveniently provided with channels 21 that lead into the first concavities 2 and which are connected to an external connector 11 that can be connected to a vacuum pump, not shown.

As an alternative or in addition, the deformation of the first sheet 3 can be obtained by moving closer to each other the mold 1 and a plurality of male plugs, not shown, the respective shape of which is substantially complementary to that of the corresponding first concavities 2 of the mold.

The deformation can optionally be made substantially permanent by way of thermoforming the first sheet 3, which is conveniently made of thermoformable material such as EVA or silicone.

To this end, the mold 1, and in particular its first concavities 2, can be conveniently heated, in a way that is known per se, to a temperature falling in the range of the temperatures of permanent deformation or of thermoforming of the material of the first sheet 3.

In addition or as an alternative, the above mentioned male plugs, if used, can be brought to such temperature.

Subsequently, each second concavity 32 of the first sheet 3 is filled with feathers, preferably goose feathers or goose down, for example with a pad of down 5 for each second concavity 32.

Each pad of down 5 is made in advance with conventional techniques and can have a convex shape on one side and be substantially flat on the other side, so that the convexity can fill a corresponding second concavity 32 formed on the first sheet 3.

Then, a second sheet 6 is anchored to the first sheet, for example by interposing a layer of adhesive between the perimetric areas 31 of the second concavities 32 and the second sheet 6 and pressing the second sheet 6 against the first sheet 3 by way of a press.

Alternatively, the anchoring between the first sheet 3 and the second sheet 6 can be achieved by way of heat-sealing, using for example a “triplure” as a second sheet, i.e. a material containing thermoplastic fibers that, when melted by heat, bond the two sheets 3 and 6 between them.

In an alternative version of the embodiment described above, the feathers can be injected after the anchoring between the first sheet 3 and the second sheet 6, by leaving a lateral pocket open between the two sheets 3 and 6 at one side of each second concavity 32, in order to allow the injection of the feathers through such pocket; such injection can be direct, i.e. without using pads 5 made in advance.

Returning to the first embodiment, after the filling and anchoring of the two sheets 3 and 6, the semi-finished product 10 thus obtained is removed from the mold 1, the selvage is optionally cut or modeled and finally it is joined to other semi-finished products obtained with a similar method but to form different portions of the item of clothing that it is desired to obtain.

In practice it has been found that the method according to the disclosure fully achieves the set aim in that makes it possible to obtain feather-filled items of clothing that are free from the traditional containment stitching used to obtain the boudin or rounded effect.

Furthermore, by way of thermoforming it is possible to have a cambered effect on only one side of the item of clothing

The method, thus conceived, is susceptible of numerous modifications and variations. Moreover, all the details may be substituted by other, technically equivalent elements.

In practice, the materials employed, as well as the dimensions, may be any according to requirements and to the state of the art.

The disclosures in Italian Patent Application No. 102016000060837 (UA2016A004345) from which this application claims priority are incorporated herein by reference.

1-7. (canceled)

8. A method of manufacturing feather-filled items of clothing, the method includes the following steps:
preparing at least one mold provided with a plurality of first concavities of shape substantially complementary to a respective padded cambered region of at least one portion of the item of clothing to be obtained;
associating a first sheet of deformable material with said mold;
deforming said first sheet against said mold so as to obtain, on said first sheet, second concavities that substantially correspond to the first concavities of said mold;
filling each second concavity of the first sheet with down;
anchoring a second sheet to said first sheet; and
removing the semi-finished product obtained in the preceding steps from said mold.

9. The method according to claim 8, wherein said anchoring includes an adhesive bonding or a heat-sealing along the regions of the first sheet that surround said second concavities.

10. The method according to claim 8, wherein said step of deforming the first sheet includes a step of depressurizing the volume defined between said first sheet and said first concavities of the mold.

11. The method according to claim 8, wherein said step of deforming the first sheet includes a thermoforming of the first sheet, obtained by depressurizing the volume defined between said first sheet and said first concavities of the mold or by moving mutually closer said mold with said first sheet and a plurality of male plugs of shape substantially complementary to the respective first concavities of said mold, either or both of said mold and said male plugs being heated to a temperature for permanent deformation of the material of said first sheet.

12. The method according to claim 8, wherein said step of filling with down includes inserting a pad filled previously with down into each one of said second concavities.

13. The method according to claim 8, wherein said filling step is performed after said anchoring step.

14. The method according to claim 8, wherein said mold is manufactured previously starting from a three-dimensional paper model.
